(19) United States
(12) Patent Application Publication
(10) Pub. No.: US 2017/0039250 A1
(43) Pub. Date: Feb. 9, 2017

(54) Method of Generating Smart Outputs in Real Time from Aggregated Data Using Data Mining Algorithms

(71) Applicants: Stephen Obol Opiyo, Pataskala, OH (US); Gladys Andiru Opiyo, Pataskala, OH (US)

(72) Inventors: Stephen Obol Opiyo, Pataskala, OH (US); Gladys Andiru Opiyo, Pataskala, OH (US)

(21) Appl. No.: 15/229,092

(22) Filed: Aug. 4, 2016

Related U.S. Application Data
(60) Provisional application No. 62/200,954, filed on Aug. 4, 2015.

(51) Int. Cl. G06F 17/30

(52) U.S. Cl. CPC G06F 17/30539; G06F 17/30867; G06F 17/30554; G06F 17/3053

(57) ABSTRACT

A method of generating smart outputs in real time from aggregated data using data mining algorithms analyzes user-submitted data or retrieved third-party data with data mining algorithms in order to produce results that help the users to make informed decisions. Users submit data, query the system, and receive smart outputs from the data mining process in real time.

The current application claims a priority to the U.S. Provisional Patent application Ser. No. 62/200,954 filed on Aug. 4, 2015.

### FIELD OF THE INVENTION

The present invention relates generally to data processing. More particularly, the present invention relates to producing smart outputs with data mining algorithms to help users make informed choices.

### BACKGROUND OF THE INVENTION

Currently, many webpages, applications and other tools exist that can output information from user queries in various ways such as text, images, charts, and more. However, most of these outputs provided by the information tools do not generate results by data mining algorithms in real time. The outputs generated are statics, or have been pre analyzed and stored in databases and are simply retrieved. For example, users of an airline enter dates and destinations for their travel, the website search the databases and return lists of prices. The outputs from the searches are not generated using data mining algorithms in real time. Outputs generated by data mining algorithms in real time would include a summary of the reviews for databases, statistical differences between prices, pro and cons of each airline, and more.

For example, a real time output generated by a data mining algorithms could provide two air tickets with a difference of only $10. Having additional information like statistical significance between the two prices could provide a user with more options to make a smart decision between the two prices.

Another example of the usefulness of the present invention deals with people, organizations or companies that sell services and products. Assume that there are four retailers in an area selling the same product; and the difference between highest and the lowest price for the product is 20 cents. Using a smart data mining algorithm, a user could compare the prices from the four retailers to find if there are significant differences for the prices in real time using data mining algorithms. They could then adjust his/her price based on the results from the data mining algorithms to stay competitive with the other retailers.

Smart data could also be used by political organizations. For example, a political candidate would want to compare internal polling results with the competitor's polls. The candidate would input the information from the polls into the present invention platform, and the data mining algorithms would generate smart outputs in real time. The output may include competitor's pros and cons on issues relevant to voters, competitor's strengths and weaknesses, reviews from voters, and other relevant information. The results would allow the candidate to adjust and change their strategies accordingly. The candidate would also have options of increasing or decreasing the areas of the polling in real time.

Another example would be a beauty and hairstylist who has a studio and would like to track his customers including expenses. Such user would typically use a tool like an excel spreadsheet to track his/her daily or monthly income/expenses. Using the present invention could help them to use data mining algorithms to report statistics of income and expenses in real time, present graphics, and reviews, and the user would be more informed for making decisions about their business based on smart outputs from the present invention.

One such example would be an installation company that would like to track customer's information, work order total, equipment and services sold, appointment date, and other aspects. The present invention would make it easy to key in information and associate all customers to each file in a real time and associate customer files for statistics and pattern tracking in a real time.

Another example would be to help colleges and universities to retain students. A university could provide information on students, including whether or not they dropped out. The present invention would analyze the data in real time to determine which students are likely to drop out.

The present invention could help users to make smart decisions in comparing prices and services based on other variables. For example, majority of web and mobile-based pages that provide users with information do not give them options for smart decisions. Take an example of a user who compared prices of a product located 5 miles apart. While the difference in prices might not be statistically different, using smart outputs from the present invention would save the user to drive a given distance because of a price difference that is not statistically different. In addition to statistical results, the smart outputs would give the user the pro and cons of driving the given distance. The cons would include time lost due to traffic, because traffic information would be included in the smart outputs.

A platform that combines information to generate outputs based on smart data allowing users to obtain outputs in real time based on data mining algorithms in a real time would be an improvement in the art. Such a platform that also allows users to make smart decisions related to provision of products and services for users would similarly constitute an improvement in the art.

### BRIEF DESCRIPTION OF THE DRAWINGS

FIG. 1 is a network diagram of the system used in the present invention.

FIG. 2 is a stepwise flow diagram describing the steps of the general method of the present invention.

FIG. 3 is a stepwise flow diagram describing uses for the personal computing device in the method of the present invention.

FIG. 4 is a stepwise flow diagram describing steps for searching external server networks for data in the method of the present invention.

FIG. 5 is a stepwise flow diagram describing steps for searching multiple sources for data in the method of the present invention.

FIG. 6 is a stepwise flow diagram describing steps for contextually identifying a user query in the method of the present invention.

FIG. 7 is a stepwise flow diagram describing steps for displaying results in the method of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

The present invention combines information to generate outputs based on smart data. The present invention gets information from users and other sources, data mining algorithms analyze the information, and outputs are generated based on the results from the algorithms in real time. The present invention may be alternately referred to throughout at the Patira platform. The Patira platform allows users to make smart decisions based on data mining algorithms in real time. Users log in over a platform connection through a computing device and are able to input information into the platform. The inputted information is analyzed by data mining algorithms, and outputs are generated to help make smart decisions. Use of the Patira platform allows users to utilize data mining algorithms, obtaining information that helps them make smart decisions, and users may add comments to the platform for future improvement. Analysis of the platform contents over time may be used to predict future needs for how to improve the Patira platform.

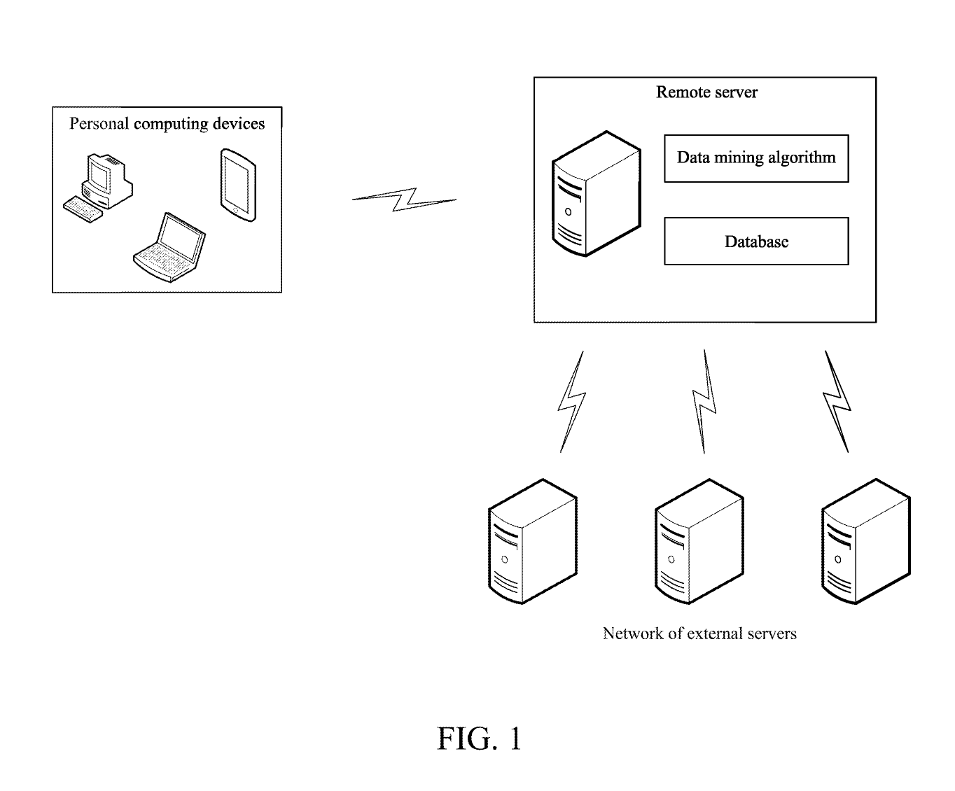

Embodiments of the present invention may be implemented by software running on a suitable computer system, cloud system, mobile electronic device system, or the like, which executes a series of computer-executable commands contained within a computer-readable medium in the system as lines of software code or machine code. A general network diagram in the present invention is shown in FIG. 1.

The present invention relates generally to a method that combines information from users and other sources to generate outputs based on the results generated by data mining algorithms in real time. It will be appreciated by those skilled in the art that the embodiments herein described, while illustrating certain embodiments, are not intended to so limit the invention. Those skilled in the art will also understand that various combinations or modifications of the embodiments presented herein can be made without departing from the scope of the invention. All such alternate embodiments are considered to be within the scope of the present invention.

In implementing the present invention into a system, various participants may be included, such as, but not limited to, subscriber users, non-subscriber users, advertisers, and donors. Users of the present invention may include, but are not limited to, buyers, sellers, colleges/universities, governmental and non-governmental organizations, companies, machines, robots, objects that use data, properties that use data, and any entities that use data, and the like.

In one embodiment of the present invention, users and other participants connect to Patira platform by login through such means as user name and password, personal accounts, social media such as Facebook, Twitter, Google, and the like.

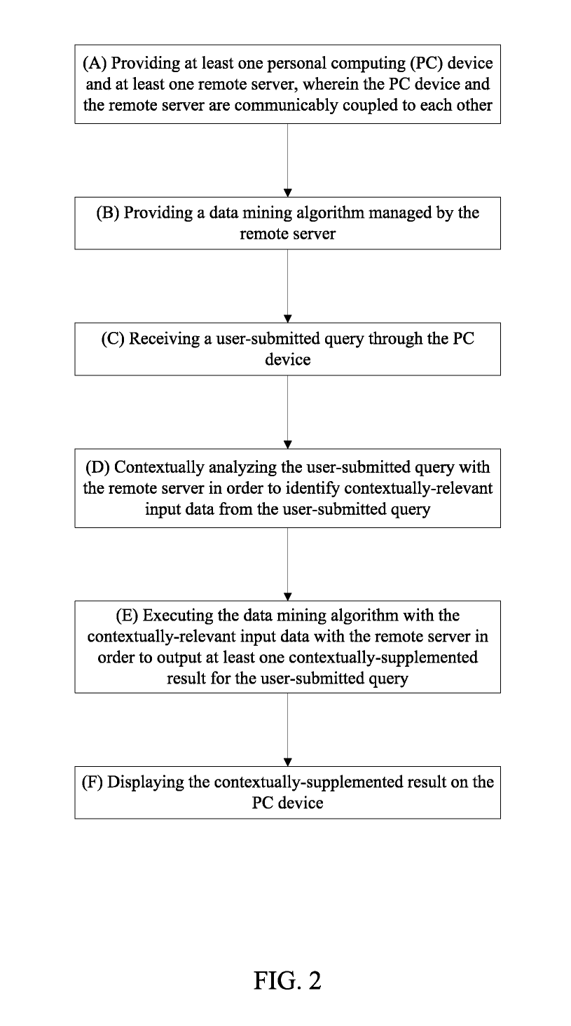

In the general method of the present invention shown in FIG. 2, at least one personal computing (PC) device is provided, in addition to at least one remote server, wherein the PC device and the remote server are communicably coupled to each other (Step A). The PC device is any electronic device capable of receiving user input, executing electronic commands and communicating with the remote server in order to facilitate the functionality of the present invention. The PC device is selected from a group consisting of a mobile computing device and a stationary computing device. The PC device may be a mobile computing device such as, but not limited to, a smartphone, a tablet, or a laptop computer, or the PC device may be a stationary computing device such as, but not limited to, a desktop computer or other type of computer workstation. Although “personal computer” is often colloquially used to refer to a stationary desktop computer, herein the PC device should be understood to be any relevant computing device with which an end-user interacts with the present invention. Each PC device is able to make an electronic connection to the remote server through any means such as, but not limited to, a direct network connection, a direct dial modem connection, or over the Internet using a secure protocol. It is preferred that secure network connections and security protocols be used to protect all users and other entities interacting with the present invention. It will be appreciated that in some embodiments of the system dedicated computer terminals may be used to conduct communications.

In the preferred embodiment, the remote server is the primary computational entity of the present invention. The remote server is any computing device which is capable of electronically communicating with all other relevant computing entities in the present invention and executing electronic commands and code in order to carry out the purpose of the present invention. It will be appreciated that although the remotes server is depicted as a computing system for simplicity, any number of different computers, cloud systems, or mobile systems functioning to act as a single system for carrying out the processes or methods described herein may be used and is within the scope of the present invention. The remote server may include or function as a Web interfacing system such as a Web server for enabling access and interaction with other devices linked to local and external communication networks (“networks”), including the World Wide Web (the “Internet”), a local area network (LAN), a wide area network (WAN), an intranet, the computer network of an online service, or other devices or systems. The remote server optionally may include one or more local displays, which may comprise a conventional monitor, a monitor coupled with an integrated display, an integrated display such as an LCD display, or other means for viewing data or processing information. One or more interface modules may also be present to support input and output between a user and the participant tracking the remote server through an interface device such as a joystick, keyboard, mouse or data glove, tablets, and smart phone touch screens. The remote server may also include a network interface (I/O) for bidirectional data communication through one or more and preferably all of the various networks (LAN, WAN, Internet, etc.) using communication paths or links known in the art, including wireless connections, Ethernet, bus line, Fiber Channel, ATM, standard serial connections, and the like.

A data mining algorithm is also provided, which the remote server manages (Step B). Multiple data mining algorithms may be provided which can be utilized for different data mining applications as desired. The data mining algorithm or algorithms embodied may include, but are not limited to, statistics, multivariate statistics, machine learning, physics, computer, chemometrics, text analytics, predictive analytics, predictive analytics, physics, geo spatial analysis, mathematics, genetics algorithms, and the like.

Smart output generated by the data mining algorithm or algorithms may include, but are not limited to, prices, locations, scores, reviews, products, services, numbers, maps, pictures, graphs, coupons, sounds, light, and the like. The smart outputs of the data mining algorithm will depend on the nature and context of the embodiment of the present invention. Furthermore, various results from data mining algorithms, such as p-values, z-values, standard errors, and other measurements may be converted in colors, shapes, graphs, sounds, and other outputs. In various embodiments, the inputs from users and outputs from the platform may include, but are not limited to, prices, objects, reviews, products, sounds, lights, services, maps, numbers, shapes, polygons, coupons, graphs, colors, and other objects, that can be inputted or outputted in clouds, computers, mobile devices, web page devices, tablets, phones, and others devices that take inputs and outputs data.

A user-submitted query is received through the PC device (Step C). The nature of the user-submitted query is flexible and may be related to any number of searches, commands or other inputs, but in general the user-submitted query is a request to the remote server to analyze data with the data mining algorithm and produce one or more outputs. For example, the user-submitted query may be a list of flights from location A to location B at a specific time, or the user-submitted query may be a list of a given type of restaurant within a given radius of a given location, or the user-submitted query may simply be a request to the remote server to statistically analyze a portion of data.

The user-submitted query is then contextually analyzed with the remote server in order to identify contextually-relevant input data from the user-submitted query (Step D). The contextually-relevant input data is any data available to the remote server to access that is relevant to the user-submitted query. In order to produce suitable outputs to the user-submitted query, the system must know what set of data to retrieve in order to perform the computation. Thus, the contextually-relevant input data is understood to be the set of data out of all data available to the system that is relevant to the user-submitted query. In one embodiment, the present invention is specialized for a singular purpose. For example, in one embodiment the present invention is specialized for food and dining establishments, and the contextually-relevant data may include restaurant locations, restaurant categories, price ranges, operating hours, and similar data. In another embodiment the present invention is specialized for finance, and the contextually-relevant data may include bank account balances, prices, interest rates, and other relevant data. In one embodiment, the present invention is capable of handling multiple areas of interest. For example, in one embodiment the present invention is capable of producing outputs for food and dining establishments, finance, travel, logistics, customer tracking, inventory tracking, and more areas of interest as desired to be implemented. Thus, the user query must be interpreted by the system to determine the correct context for producing outputs for the user-submitted query.

The data mining algorithm is then executed with the contextually-relevant input data with the remote server in order to output at least one contextually-supplemented result for the user-submitted query (Step E). The contextually-supplemented result is then displayed on the PC device from which the user query originated (Step F). The contextually-supplemented results are the end goal of the present invention, the smart outputs produced by the system which enable the user to make more informed choices.

In one embodiment, a database is further provided. The database is accessible through the remote server. The database functions in the present invention to store any relevant data collected by the present invention. The database should be understood to be a repository for data, and may be a digital repository comprised with the remote server on a computer-readable medium, or the database may be a physical database system with similar computer-readable medium storing said repository, which the remote server is able to access.

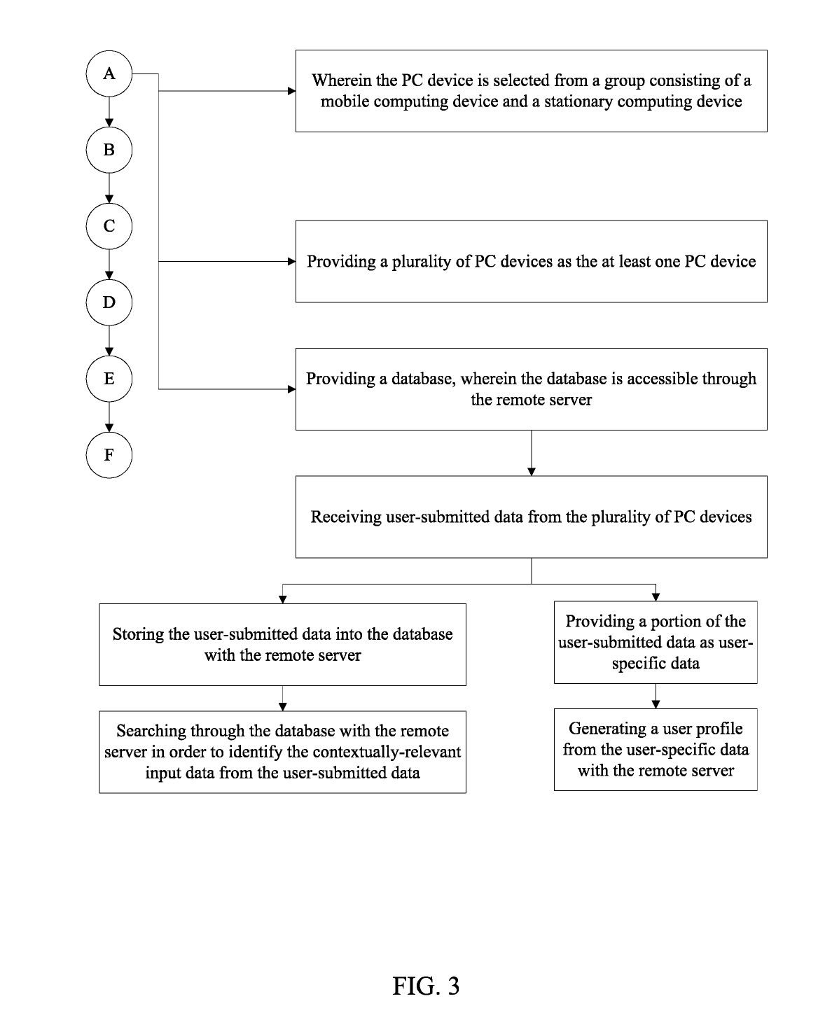

As shown in FIG. 3, in one embodiment, a plurality of PC devices is provided as the at least one PC device. Data is collected through the plurality of PC devices in order to build a set of data on which to execute the data-mining algorithm. To this end, user-submitted data is received from the plurality of PC devices, and the user-submitted data is stored into the database with the remote server. Users may manually submit data which can be later used to produce smart outputs with the system. For example, users may manually submit restaurant names, locations, prices, and operating hours, which may later be used to provide results to a user. The database is then searched through with the remote server in order to identify the contextually-relevant input from the user-submitted data.

In one embodiment, a portion of the user-submitted data is user-specific data. A user profile is generated for each of the PC devices from the corresponding user-specific data of the PC devices with the remote server. The user-specific data may include, but is not limited to, device identification, interaction history with the system, device location, and other data specific to each PC device.

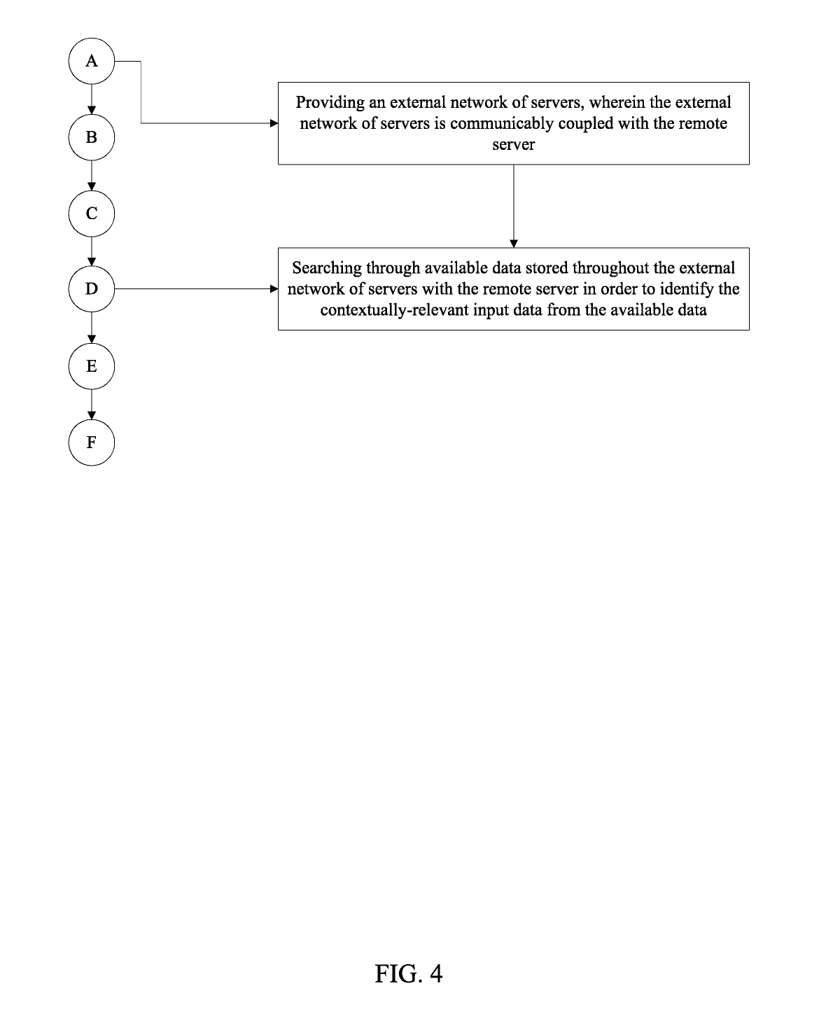

As shown in FIG. 4, in one embodiment, an external network of servers is provided, wherein the external network of servers is communicably coupled with the remote server. Available data stored throughout the external network of servers is searched through in order to identify the contextually-relevant input data from the available data. The external network of servers may be, but is not limited to, the Internet, or other data sources such as third-party databases. In one embodiment, the remote server visits various websites on the Internet stored on the external network of servers and captures information from the websites in order to identify the contextually-relevant input data. For example, the remote server may search several airline websites to obtain flight information to compare and analyze.

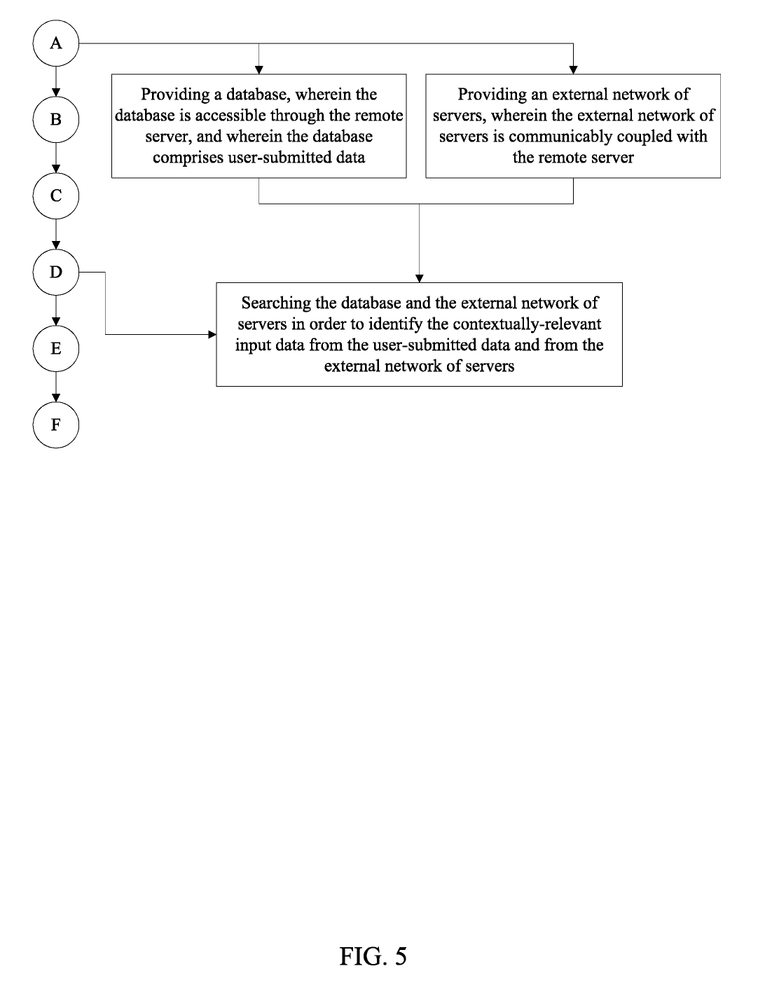

As shown in FIG. 5, in one embodiment, the database and the external network of servers are both provided. Thus, the database and the external network of servers are both searched in order to identify the contextually-relevant input data from the user-submitted data and from the available data on the external network of servers.

In one embodiment, only user-submitted data stored in the database is used as the contextually-relevant input data to the data mining algorithm. In one embodiment, only the available data on the external network of servers is used as the contextually-relevant input data. In one embodiment, both the user-submitted data and the available data from the external network of servers is used as the contextually-relevant input data.

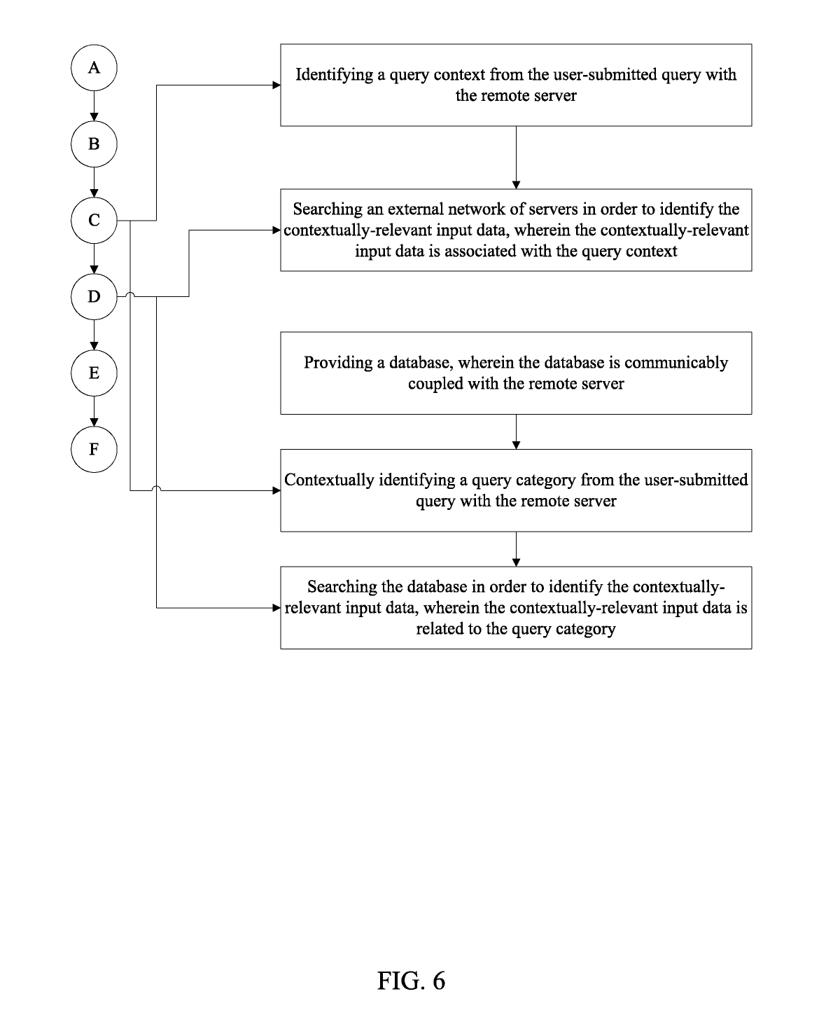

As shown in FIG. 6, in one embodiment, a query context is identified from the user-submitted query with the remote server. The external network of servers is then searched in order to identify the contextually-relevant input data, wherein the contextually-relevant input data is associated with the query context. Alternatively stated, in one embodiment, the system can handle multiple applications and thus interprets the user-submitted query to ascertain the context of the query, and the system captures the relevant data from Internet sites or third-party databases in order to produce the smart output.

Similarly, in one embodiment, a query category is contextually identified with the remote server, and the database is searched in order to identify the contextually-relevant input data, wherein the contextually-relevant input data is related to the query category.

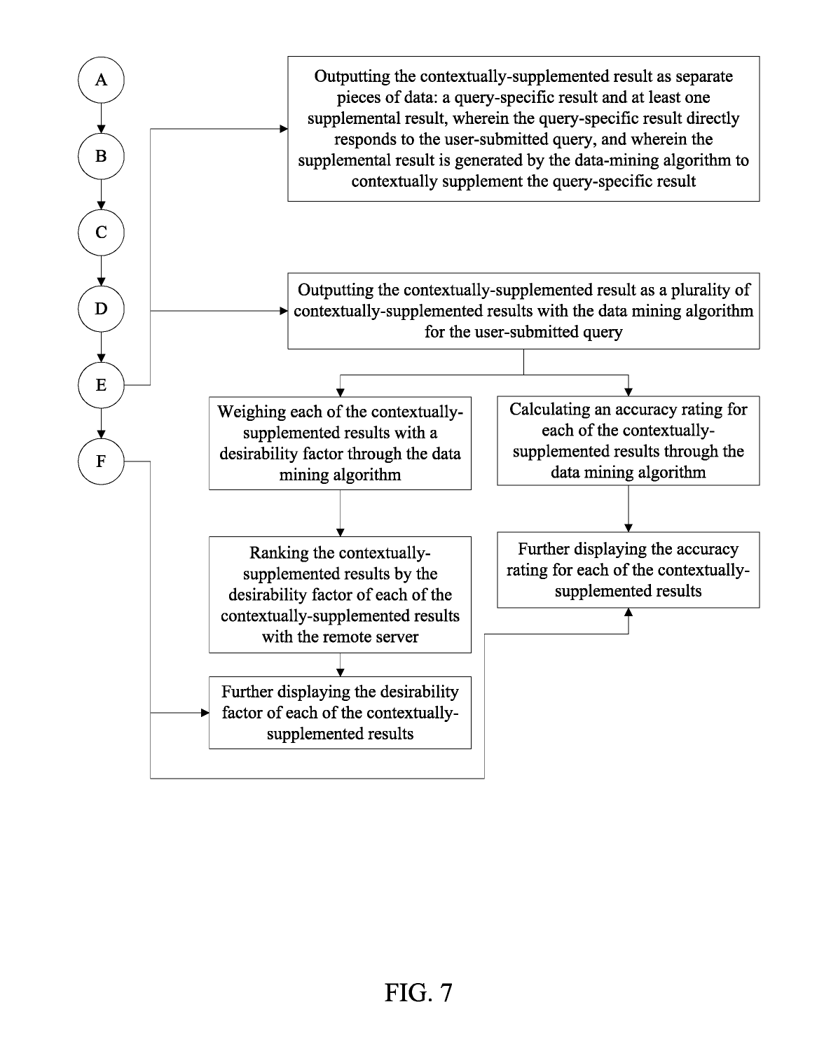

As shown in FIG. 7, in one embodiment, the contextually-supplemented result is outputted as separate pieced of data: a query-specific result and at least one supplemental result. The query-specific result directly responds to the user-submitted query, and the supplemental result is generated by the data mining algorithm to contextually supplement the query-specific result. The query-specific result is the direct response to the user-submitted query. For example, if the user-submitted query is for restaurants of a certain category in a certain area, the query-specific result is the data corresponding to the restaurants of the certain category in the certain area. The supplemental result or results are additional data or other results that may add value to the user beyond the requested data, such as reviews of the restaurants, traffic from the user's current location to the restaurants, and price ranges of the restaurants.

In one embodiment, the contextually-supplemented result is outputted as a plurality of contextually-supplemented results with the data mining algorithm for the user-submitted query. Each of the contextually-supplemented results is weighed with a desirability factor through the data mining algorithm, and the contextually-supplemented results are ranked by the desirability factor of each of the contextually-supplemented results with the remote server. The desirability factor of each of the contextually-supplemented results is further displayed on the PC device. For example, a user desired to compare prices of a product at various locations. A first retailer may sell the product for 50 cents less than a second retailer, but the route from the user to the retailer has heavy traffic which would require significantly more travel time than to the second retailer. The system would then display a desirability indicator next to the two listings; for example, a yellow indicator next to the first retailer listing due to the high travel time, and a green indicator next to the second retailer listing, indicating a better recommended choice. The system will weigh various factors with the data mining algorithm to produce recommendations for the user to make more informed decisions.

In one embodiment, the contextually-supplemented result is again outputted as a plurality of contextually-supplemented results with the data mining algorithm for the user query. An accuracy rating is calculated for each of the contextually-supplemented results through the data mining algorithm, and the accuracy rating is further displayed for each of the contextually-supplemented results on the PC device. The accuracy rating reflects the probability that the smart output produced by the data mining algorithm is accurate, as calculated by any relevant statistical analysis means.

A potential feature of the present invention is to include subscriptions and advertisements. Non-subscribed users would be shown advertisements, and subscribed users would not be shown advertisements in exchange for a subscription fee. Advertisers will be able to access a backend interface with the present invention in order to manage advertising campaigns.

Users may also access the platform and update the stored information to improve the platform. Inaccurate or out of date data may be corrected through user submission of new data.

Although the invention has been explained in relation to its preferred embodiment, it is to be understood that many other possible modifications and variations can be made without departing from the spirit and scope of the invention as hereinafter claimed.

What is claimed is:

1. A method of generating smart outputs in real time from aggregated data using data mining algorithms comprises the steps of:
(A) providing at least one personal computing (PC) device and at least one remote server, wherein the PC device and the remote server are communicably coupled to each other;
(B) providing a data mining algorithm managed by the remote server;
(C) receiving a user-submitted query through the PC device;
(D) contextually analyzing the user-submitted query with the remote server in order to identify contextually-relevant input data from the user-submitted query;
(E) executing the data mining algorithm with the contextually-relevant input data with the remote server in order to output at least one contextually-supplemented result for the user-submitted query; and
(F) displaying the contextually-supplemented result on the PC device.

2. The method of generating smart outputs in real time from aggregated data using data mining algorithms by executing computer-executable instructions stored on a non-transitory computer-readable medium as claimed in claim 1, wherein the PC device is selected from a group consisting of a mobile computing device and a stationary computing device.

3. The method of generating smart outputs in real time from aggregated data using data mining algorithms by executing computer-executable instructions stored on a non-transitory computer-readable medium as claimed in claim 1 comprises the steps of:
providing a database, wherein the database is accessible through the remote server;
providing a plurality of PC devices as the at least one PC device;
receiving user-submitted data from the plurality of PC devices;
storing the user-submitted data into the database with the remote server; and
searching through the database with the remote server in order to identify the contextually-relevant input data from the user-submitted data.

4. The method of generating smart outputs in real time from aggregated data using data mining algorithms by executing computer-executable instructions stored on a non-transitory computer-readable medium as claimed in claim 3 comprises the steps of:
providing a portion of the user-submitted data as user-specific data; and
generating a user profile from the user-specific data with the remote server.

5. The method of generating smart outputs in real time from aggregated data using data mining algorithms by executing computer-executable instructions stored on a non-transitory computer-readable medium as claimed in claim 1 comprises the steps of:
providing an external network of servers, wherein the external network of servers is communicably coupled with the remote server; and
searching through available data stored throughout the external network of servers with the remote server in order to identify the contextually-relevant input data from the available data.

6. The method of generating smart outputs in real time from aggregated data using data mining algorithms by executing computer-executable instructions stored on a non-transitory computer-readable medium as claimed in claim 1 comprises the steps of:
providing a database, wherein the database is accessible through the remote server, and wherein the database comprises user-submitted data;
providing an external network of servers, wherein the external network of servers is communicably coupled with the remote server; and
searching the database and the external network of servers in order to identify the contextually-relevant input data from the user-submitted data and from the external network of servers.

7. The method of generating smart outputs in real time from aggregated data using data mining algorithms by executing computer-executable instructions stored on a non-transitory computer-readable medium as claimed in claim 1 comprises the steps of:
identifying a query context from the user-submitted query with the remote server; and
searching an external network of servers in order to identify the contextually-relevant input data, wherein the contextually-relevant input data is associated with the query context.

8. The method of generating smart outputs in real time from aggregated data using data mining algorithms by executing computer-executable instructions stored on a non-transitory computer-readable medium as claimed in claim 1 comprises the steps of:
providing a database, wherein the database is communicably coupled with the remote server;
contextually identifying a query category from the user-submitted query with the remote server; and
searching the database in order to identify the contextually-relevant input data, wherein the contextually-relevant input data is related to the query category.

9. The method of generating smart outputs in real time from aggregated data using data mining algorithms by executing computer-executable instructions stored on a non-transitory computer-readable medium as claimed in claim 1 comprises the steps of:
outputting the contextually-supplemented result as separate pieces of data:
a query-specific result and at least one supplemental result, wherein the query-specific result directly responds to the user-submitted query, and wherein the supplemental result is generated by the data-mining algorithm to contextually supplement the query-specific result.

10. The method of generating smart outputs in real time from aggregated data using data mining algorithms by executing computer-executable instructions stored on a non-transitory computer-readable medium as claimed in claim 1 comprises the steps of:
outputting the contextually-supplemented result as a plurality of contextually-supplemented results with the data mining algorithm for the user-submitted query;
weighing each of the contextually-supplemented results with a desirability factor through the data mining algorithm;
ranking the contextually-supplemented results by the desirability factor of each of the contextually-supplemented results with the remote server; and
further displaying the desirability factor of each of the contextually-supplemented results.

11. The method of generating smart outputs in real time from aggregated data using data mining algorithms by executing computer-executable instructions stored on a non-transitory computer-readable medium as claimed in claim 1 comprises the steps of:
outputting the contextually-supplemented result as a plurality of contextually-supplemented results with the data mining algorithm for the user-submitted query;
calculating an accuracy rating for each of the contextually-supplemented results through the data mining algorithm; and
further displaying the accuracy rating for each of the contextually-supplemented results.
